(19) United States
(12) Patent Application Publication
(10) Pub. No.: US 2026/0241843 A1
(43) Pub. Date: Aug. 20, 2026

(54) SAFETY SEAT AND SEAT FABRIC STRUCTURE THEREOF

(71) Applicant: Wonderland Switzerland AG, Steinhausen (CH)

(72) Inventors: Liuhui HU, Guangdong (CN); Hui WU, Guangdong (CN); Xin CHEN, Guangdong (CN)

(73) Assignee: Wonderland Switzerland AG, Steinhausen (CH)

(21) Appl. No.: 19/542,254

(22) Filed: Feb. 17, 2026

(30) Foreign Application Priority Data
Feb. 20, 2025 (CN) 2025101933432

(51) Int. Cl. B60N 2/58; B60N 2/90

(52) U.S. Cl. CPC B60N 2/58; B60N 2/90

(57) ABSTRACT

A seat fabric structure for a safety seat includes a seat fabric and a shielding piece. The seat fabric covers a seat body of the safety seat, and the seat fabric has a through slot to allow a crotch strap of the safety seat to pass through. The shielding piece is connected to the seat fabric and configured to shield the through slot.

### CROSS-REFERENCE TO RELATED APPLICATION

The present disclosure claims priority to Chinese Application No. 202510193343.2 filed on February 20, 2025, which is incorporated herein by reference in its entirety.

### TECHNICAL FIELD

The present disclosure relates to a safety seat and a seat fabric structure thereof.

### BACKGROUND

Safety seats are seats specially designed for passengers of different ages and different weights, which can effectively protect safety of the passengers during driving of vehicles. At present, a commonly used safety seat includes a seat body, a seat fabric covering the seat body, and a safety belt connected to the seat body. A crotch strap of the safety belt is typically connected to a seat portion of the seat body, and a through slot needs to be correspondingly provided in the seat fabric to allow the crotch strap to pass through, and in turn allow the crotch strap to be exposed out of the safety seat to contact a passenger’s crotch. Since the seat fabric at the through slot is sewn by stitching lines, it may cause a part of the seat fabric at the through slot to be unable to keep flat with another part of the seat fabric around the through slot. Especially when the seat fabric includes a plurality of through slots for position adjustment of the crotch strap, the seat fabric provided with the plurality of through slots may be more uneven. Since this part of the seat fabric is located exactly at the passenger’s crotch, the unevenness of the seat fabric not only affects aesthetics, but also compromises comfort of the passenger.

### SUMMARY

The present disclosure aims to provide a safety seat and a seat fabric structure thereof. The seat fabric structure of the safety seat is more aesthetic and flatter overall, making it more comfortable for passengers to sit on.

According to one aspect of the present disclosure, a seat fabric structure for a safety seat includes a seat fabric and a shielding piece. The seat fabric covers a seat body of the safety seat and has at least one through slot to allow a crotch strap of the safety seat to pass through. The shielding piece is connected to the seat fabric and configured to shield the at least one through slot.

According to some embodiments of the present disclosure, a first end of the shielding piece is fixedly connected to the seat fabric, and a second end of the shielding piece is detachably connected to the seat fabric.

According to some embodiments of the present disclosure, the at least one through slot comprises at least one pair of through slots, the at least one pair of through slots are provided on the safety seat along a first direction of the safety seat, each pair of the at least one pair of through slots includes two through slots disposed opposite to each other in a second direction of the safety seat, and the second direction is perpendicular to the first direction.

According to some embodiments of the present disclosure, a dimension of the shielding piece in the second direction is greater than or equal to a sum of a distance between two through slots in each pair of the at least one pair of through slots and dimensions of the two through slots in the second direction.

According to some embodiments of the present disclosure, a dimension of the shielding piece in the first direction is greater than or equal to a distance between two points of all of the at least one pair of through slots which are distanced farthest apart in the first direction.

According to some embodiments of the present disclosure, the seat fabric further has at least one connecting slot extending along the second direction, and at least one pair of the at least one pair of through slots are in communication with each other via one of the at least one connecting slot.

According to some embodiments of the present disclosure, the at least one pair of through slots includes at least two pairs of through slots, and all the through slots located on a same side of the second direction and belonging to different pairs are in communication with each other.

According to some embodiments of the present disclosure, the one of the at least one connecting slot is connected to ends of the one pair of the at least two pairs of through slots located at an end along the first direction.

According to some embodiments of the present disclosure, the one of the at least one connecting slot is located between two adjacent pairs of the at least two pairs of through slots, and is simultaneously in communication with the two adjacent pairs of the at least two pairs of through slots.

According to some embodiments of the present disclosure, the at least one pair of through slots includes at least two pairs of through slots, and at least two adjacent through slots located on a same side of the second direction and belonging to different pairs are separated from each other.

According to some embodiments of the present disclosure, each pair of the at least two pairs of through slots are in communication through one connecting slot.

According to some embodiments of the present disclosure, the one of the at least one connecting slot and the through slots in communication with the one of the at least one connecting slot define an adjusting piece from the seat fabric, one side of the adjusting piece is integrated with the seat fabric, and other sides of the adjusting piece are separated from the seat fabric by the one of the at least one connecting slot and the through slots.

According to another aspect of the present disclosure, a safety seat includes: a seat body having at least one limiting hole; a seat fabric covering the seat body and having at least one through slot corresponding to the at least one limiting hole; a shielding piece connected to the seat fabric and configured to shield the at least one through slot; and a crotch strap assembly passing through the at least one through slot and the at least one limiting hole to be connected to the seat body.

According to some embodiments of the present disclosure, the crotch strap assembly includes a crotch strap, and the crotch strap extends from an outer side of the shielding piece into the at least one through slot and the at least one limiting hole.

According to some embodiments of the present disclosure, the at least one limiting hole comprises at least one pair of limiting holes, the at least one pair of limiting holes are provided on the safety seat along a first direction of the safety seat, and each pair of the at least one pair of limiting holes includes two limiting holes disposed opposite to each other in a second direction of the safety seat. The second direction is perpendicular to the first direction. The seat fabric has a corresponding pair of through slots corresponding to each pair of the at least one pair of limiting holes.

According to some embodiments of the present disclosure, the at least one pair of limiting holes includes at least two pairs of limiting holes. On a same side of the second direction, any two adjacent limiting holes belonging to different pairs are separated from each other, and all the through slots belonging to different pairs are in communication with each other.

According to some embodiments of the present disclosure, the crotch strap includes two positioning segments, and the two positioning segments respectively pass through two limiting holes in any one pair of the at least one pair of limiting holes.

According to some embodiments of the present disclosure, the crotch strap assembly further includes two blocking members, and the two blocking members are respectively connected to the two positioning segments to prevent the two positioning segments from disengaging from the one pair of the at least one pair limiting holes.

According to some embodiments of the present disclosure, the seat fabric further has at least one connecting slot extending along the second direction, and at least one pair of the at least one pair of through slots are in communication via the at least one connecting slot.

According to some embodiments of the present disclosure, a first end of the shielding piece is fixedly connected to the seat fabric, while a second end of the shielding piece is detachably connected to the seat fabric, and the at least one connecting slot is closer to the first end than the second end.

According to some embodiments of the present disclosure, the safety seat further includes a buckle, and the crotch strap is slidably disposed through the buckle.

According to some embodiments of the present disclosure, the buckle is a five-point safety belt buckle, and a waist strap and a shoulder strap of the safety seat are both connected to the five-point safety belt buckle; alternatively, the buckle is a waist strap positioning buckle, and the waist strap positioning buckle is configured to be connected with a safety belt of a vehicle.

According to some embodiments of the present disclosure, the crotch strap has an adjusting segment, and the adjusting segment is configured to adjust a length of the crotch strap between the limiting hole and the buckle.

It should be understood that the above general description and the following detailed description are only exemplary and explanatory and do not limit the present disclosure.

### BRIEF DESCRIPTION OF THE DRAWINGS

The accompanying drawings are included herein to provide a further understanding of the present disclosure, and are incorporated into and constitute a part of this specification. The accompanying drawings illustrate embodiments of the present disclosure and, together with the following description, serve to explain concepts of the present disclosure.

FIG. 1 is a perspective view of a safety seat according to a first embodiment of the present disclosure.

FIG. 2 is a top perspective view of the safety seat of FIG. 1, in which a crotch strap extends from two sides of a shielding piece to below the shielding piece.

FIG. 3 is a perspective view of the safety seat of FIG. 1, in which a seat fabric structure, a shoulder strap, a waist strap, and a crotch strap protector are all removed, and the crotch strap is at a first position.

FIG. 4 is a top perspective view of the safety seat in FIG. 3.

FIG. 5 is a perspective view of the safety seat in FIG. 3, with the crotch strap at a second position.

FIG. 6 is a perspective view of the safety seat in FIG. 3 after a crotch strap assembly and a buckle are removed.

FIG. 7 is a perspective view of the crotch strap assembly and the buckle of the safety seat in FIG. 3.

FIG. 8 is a perspective view of a safety seat according to a second embodiment of the present disclosure, in which a seat fabric structure is removed.

FIG. 9 is a perspective view of a seat portion of a seat body of the safety seat in FIG. 8.

FIG. 10 is a partial plan view of a crotch strap assembly and a buckle of the safety seat in FIG. 8.

FIG. 11 is a schematic view of a first implementation of a seat fabric structure of the safety seat according to the present disclosure.

FIG. 12 is a schematic view of a second implementation of the seat fabric structure of the safety seat according to the present disclosure.

FIG. 13 is a schematic view of a third implementation of the seat fabric structure of the safety seat according to the present disclosure.

FIG. 14 is a schematic view simply showing other implementations of the seat fabric structure of the safety seat according to the present disclosure.

Reference numerals:

1 safety seat

10 seat body

11 seat portion

110 limiting hole

110A first pair of limiting holes

110B second pair of limiting holes

12 backrest portion

20 seat fabric structure

210 seat fabric

2110 through slot

2120 connecting slot

2130 adjusting piece

2140 second connecting portion

220 shielding piece

2210 first end

2220 second end

2230 first connecting portion

30 crotch strap assembly

310 crotch strap

3110 positioning segment

3120 adjusting segment

3121 folded portion

320 blocking member

3210 middle connecting bar

40 buckle

410 through hole

420 connecting rod

50 waist strap

60 shoulder strap

70 base

80 crotch strap protector

### DETAILED DESCRIPTION

To further describe the principles and structures of the present disclosure, some embodiments of the present disclosure will now be described in detail in conjunction with the accompanying drawings. However, it should be understood that the embodiments described are merely exemplary, and the present disclosure should not be construed as being limited to the embodiments set forth herein.

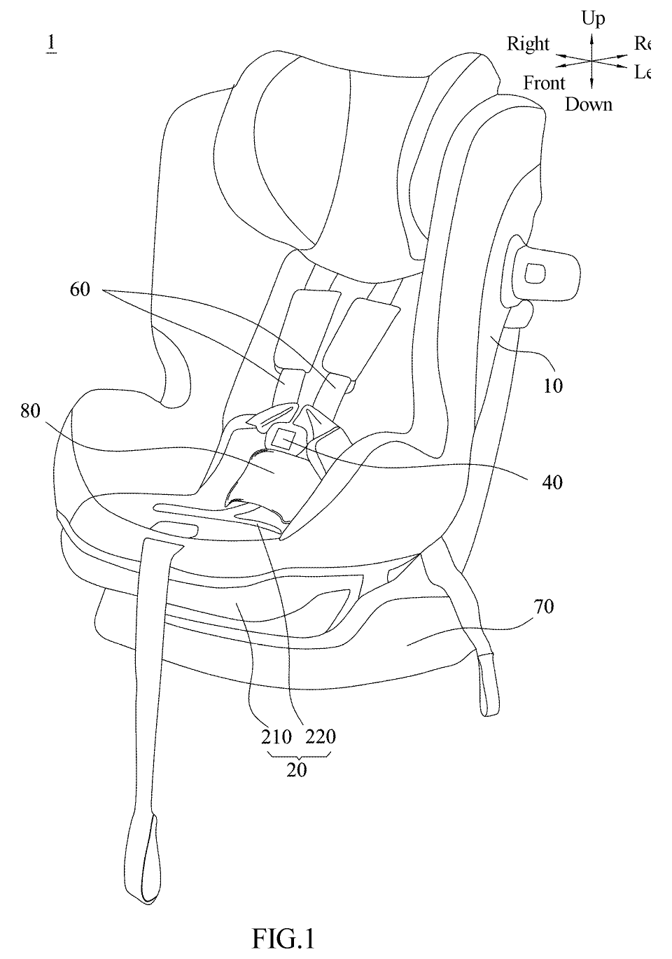

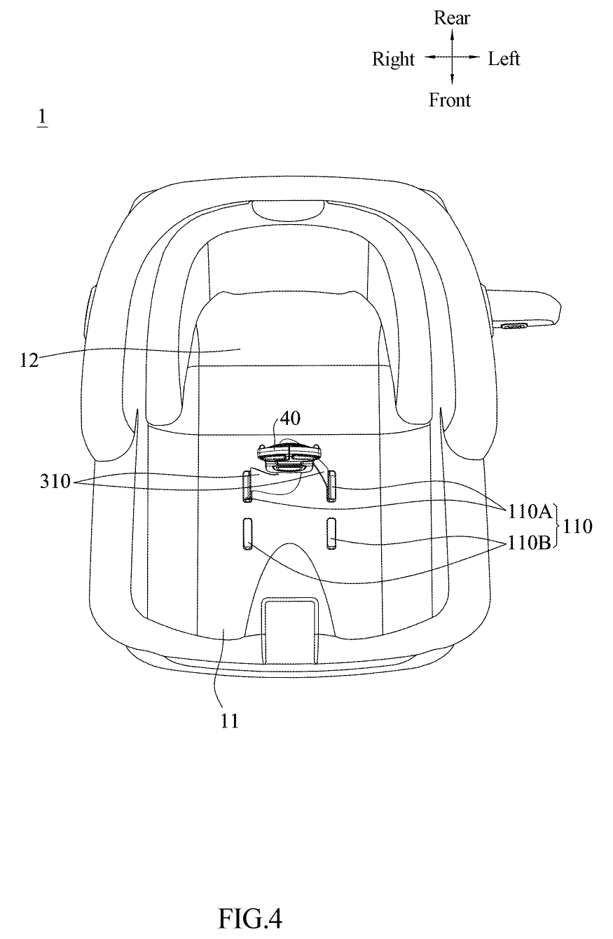

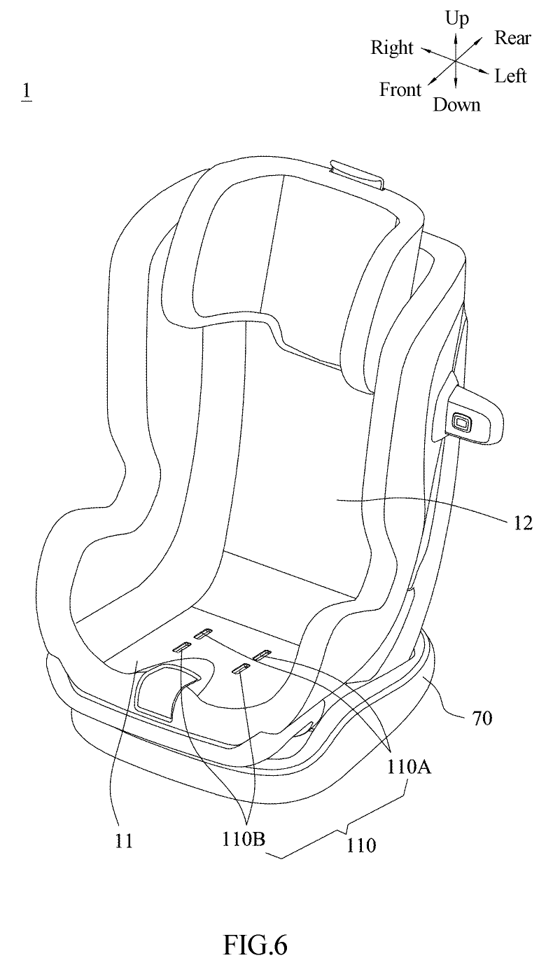

A carrier (e.g., child safety seat, stroller) according to the present disclosure may be used for passengers of different ages and different weights. A child safety seat will be taken as an example below to describe the safety seat and a seat fabric structure thereof in detail with reference to FIGS. 1 to 14 and in combination with specific embodiments. The connection and positional relationships between the stroller and its seat fabric structure can be referenced to the aforementioned child safety seat and its seat fabric structure. In addition, for ease of understanding and description, orientation terms such as front, rear, left, right, up and down herein refer to orientations of the safety seat during normal use (for example, during normal use, a seat body of the safety seat is in a forward-facing position, and a passenger sitting on the safety seat faces the front of the vehicle, in which case a direction that the passenger faces away is the rear, and the left, right, up, and down are determined accordingly). It should be understood that the present disclosure is not limited to these orientations, but may be adjusted according to actual situations.

A safety seat 1 of the present disclosure may include a seat body 10, a seat fabric structure 20 covering an outside of the seat body 10, and a safety belt connected to the seat body 10. The seat body 10 may include a seat portion 11 and a backrest portion 12 located behind the seat portion 11. Optionally, the seat portion 11 and the backrest portion 12 may be integrally formed, or the seat portion 11 and the backrest portion 12 are separately provided. The safety belt may include a crotch strap assembly 30, and the crotch strap assembly 30 includes a crotch strap 310. The crotch strap 310 passes through the seat fabric structure 20 to be connected to the seat body 10. In use, the crotch strap 310 is typically located between legs of a passenger and contacts thighs and hips of the passenger, to ensure that the passenger can be effectively fixed on the safety seat 1 in the event of vehicle collisions, thereby ensuring safety of the passenger. To make the passenger sit more comfortably, the crotch strap 310 usually features an adjustable design, and the passenger can adjust a position and a length of the crotch strap 310 according to a body shape.

The position of the crotch strap specifically refers to a position where the crotch strap 310 is connected to the seat portion 11 of the seat body 10. The crotch strap 310 may be connected to the seat portion 11 at a single point (i.e., only at one position). However, the single-point connection of the crotch strap 310 during use usually directly faces the passenger’s genital organ, which is likely to cause a sense of pressure or discomfort to the genital organ. In this regard, the crotch strap 310 may adopt multi-point connection; for example, the crotch strap 310 is connected to the seat portion 11 at two different positions on both sides of the genital organ, to avoid the genital organs during use. In the multi-point connection design, the number of the crotch straps 310 may be, for example, two. First ends (e.g., upper ends) of the two crotch straps 310 are both connected to a buckle 40 (described in detail below) of the safety seat 1, and second ends (e.g., lower ends) of the two crotch straps 310 are connected to two different positions of the seat portion 11. Alternatively, the number of the crotch strap 310 is one. The crotch strap 310 passes through the buckle 40 at a middle position of the crotch strap, and two ends of the crotch strap 310 are respectively connected to two different positions of the seat portion 11.

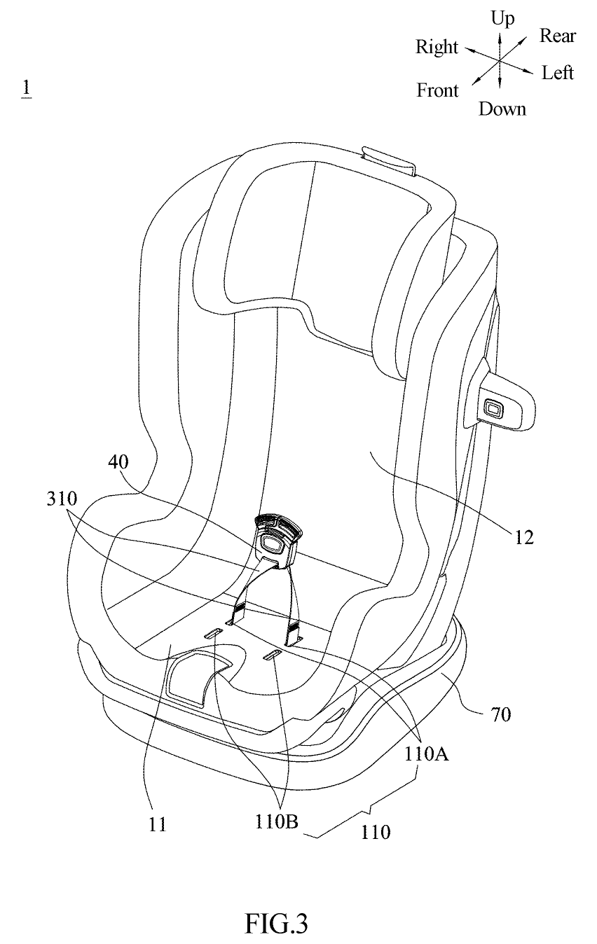

In a first embodiment shown in FIGS. 1 to 7, the seat portion 11 and the backrest portion 12 are integrally formed, the safety seat 1 may further include a base 70, and the seat body 10 is mounted on the base 70 and is adjustable in its tilt angle relative to the base 70. The passenger may adjust the position of the crotch strap 310 according to the body shape. The position where the crotch strap 310 is connected to the seat portion 11 may be adjusted by a plurality of limiting holes 110. Optionally, as shown in FIGS. 3 to 6, the plurality of limiting holes 110 may be provided in pairs on the seat portion 11 of the seat body 10 and form a plurality of pairs. The plurality of pairs of limiting holes 110 are arranged side by side along a first direction of the safety seat 1. FIGS. 3 to 6 schematically show two pairs of limiting holes, namely, a first pair of limiting holes 110A and a second pair of limiting holes 110B, but it should be understood that the present disclosure is not limited thereto. Two limiting holes 110 in each pair of limiting holes 110 may be disposed opposite to each other in a second direction of the safety seat 1 and spaced apart from each other by a certain distance. Optionally, the first direction is perpendicular to the second direction. Optionally, the first direction may be a front-rear direction, to facilitate adjustment of a distance between the crotch strap 310 and the backrest portion 12; and the second direction may be a left-right direction, to allow the crotch strap 310 to be connected to the seat portion 11 at two different positions, thereby avoiding the genital organ. Certainly, it can be understood that, in the single-point connection design, the position where the crotch strap 310 is connected to the seat portion 11 is also adjustable, in which case the plurality of limiting holes 110 may be arranged along the first direction, and each limiting hole 110 may be centrally disposed on the seat portion 11 along the second direction.

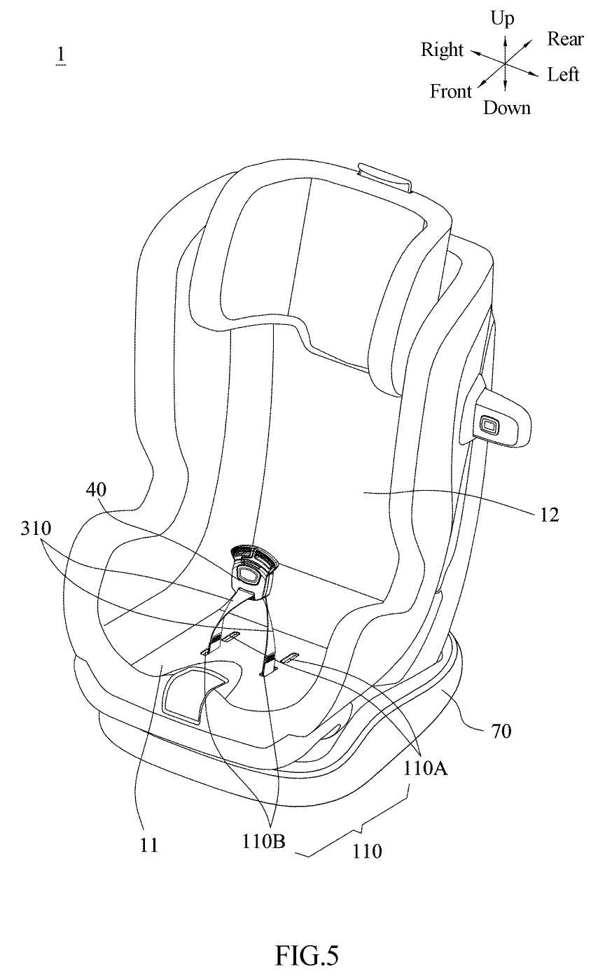

In addition, as shown in FIGS. 3 to 7, the safety seat 1 includes one crotch strap 310. The crotch strap 310 includes two positioning segments 3110 (i.e., portions of the crotch strap 310 configured to extend into the limiting holes 110), and a portion of the crotch strap 310 between the two positioning segments 3110 passes through and is disposed in a buckle 40 of the safety seat 1. Since the plurality of pairs of limiting holes 110 are spaced apart in the front-rear direction, the two positioning segments 3110 may extend into two limiting holes 110 in any pair of limiting holes 110 and be positioned in the two limiting holes 110 in any pair of limiting holes 110. For example, the two positioning segments 3110 extend into the first pair of limiting holes 110A and are positioned in the first pair of limiting holes 110A, that is, the crotch strap 310 is at a first position as shown in FIG. 3 (i.e., a rearward position). When position adjustment is required, the two positioning segments 3110 of the crotch strap 310 may be withdrawn from the first pair of limiting holes 110A, then extend into the second pair of limiting holes 110B and be positioned in the second pair of limiting holes 110B, that is, the crotch strap 310 is at a second position as shown in FIG. 5 (i.e., a forward position). Typically, for a passenger with a larger body shape, the crotch strap 310 may be adjusted forward to increase space between the crotch strap 310 and the backrest portion 12; for a passenger with a smaller body shape, the crotch strap 310 may be adjusted rearward to ensure tight contact between the crotch strap 310 and the passenger’s body. Thus, the front-rear adjustment function of the crotch strap 310 allows the crotch strap 310 to adapt to passengers of different body shapes, thereby providing a more secure fit while ensuring comfort.

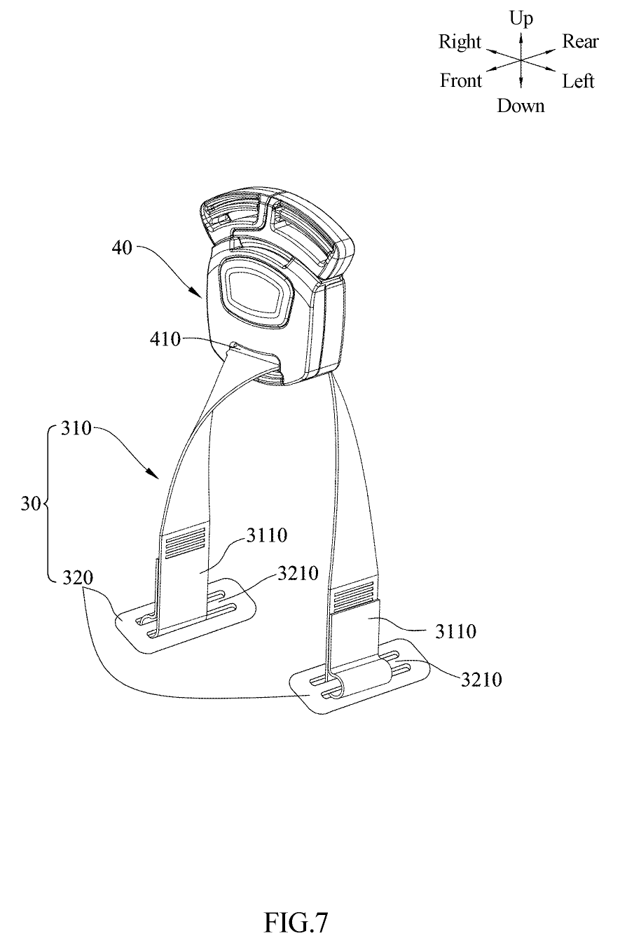

In addition, the crotch strap assembly 30 may further include a blocking member 320. Optionally, the blocking member 320 may be connected to each of the two positioning segments 3110 of the crotch strap 310. For example, one end of each positioning segment 3110 may extend into the blocking member 320, and extend reversely to be connected to another end of the positioning segment 3110 (e.g., sewn together) after the positioning segment 3110 is wound around a middle connecting bar 3210 of the blocking member 320, thereby realizing connection between the positioning segment 3110 and the blocking member 320, to prevent the blocking member 320 from slipping off the positioning segment 3110. A dimension of the blocking member 320 is smaller than a dimension of the limiting hole 110 in at least one direction, so that the blocking member 320 and the positioning segment 3110 may enter the limiting hole 110; meanwhile, the dimension of the blocking member 320 is larger than the dimension of the limiting hole 110 in at least another direction, so that the blocking member 320 may prevent the positioning segment 3110 from disengaging from the limiting hole 110. Optionally, as shown in FIG. 7, the blocking member 320 adopts a ladder buckle, and the "ladder buckle" refers to a substantially rectangular ring having at least one middle connecting bar 3210. The positioning segment 3110 is sleeved over the middle connecting bar 3210. For example, when the positioning segment 3110 needs to be inserted into the limiting hole 110, the ladder buckle first passes through the limiting hole 110 with its side edge, and then abuts against the seat body 10 at the limiting hole 110 with its rectangular plane, thereby preventing the positioning segment 3110 connected thereto from disengaging from the limiting hole 110. Certainly, the present disclosure is not limited thereto, and the crotch strap assembly 30 may not include the blocking member 320, that is, the positioning segment 3110 is positioned in the limiting hole 110 by itself without requiring the blocking member 320. For example, the positioning segment 3110 of the crotch strap 310 extending into the limiting hole 110 may form a bow by being folded multiple times relative to itself, and a dimension of the bow is larger than that of the limiting hole 110 to prevent the crotch strap 310 from disengaging from the limiting hole 110.

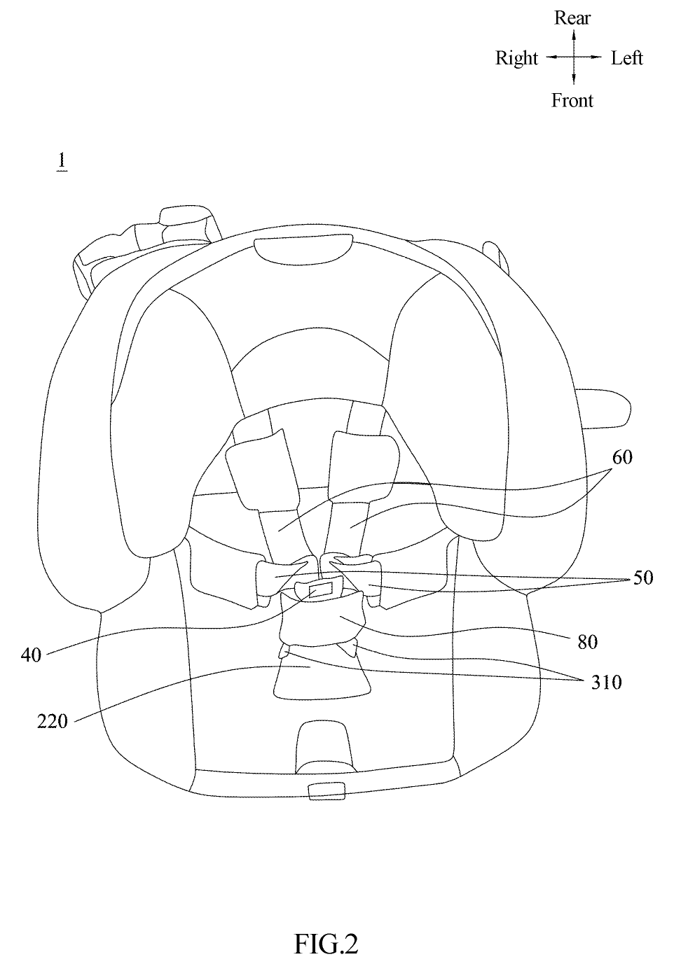

Referring to FIGS. 1 to 5 and 7, the safety seat 1 may further include a buckle 40, and the buckle 40 is connected to the crotch strap 310. As shown in FIGS. 3 to 5 and 7, the buckle 40 is a five-point safety belt buckle, and the crotch strap 310 may be slidably disposed through the buckle 40 (a position where the crotch strap 310 is disposed through the buckle is regarded as one connection point). In addition, in conjunction with FIG. 2, the safety belt of the safety seat further includes two waist straps 50 (two connection points) and two shoulder straps 60 (two connection points), which are all connected to the buckle 40 (i.e., adopting a harness use mode). In this embodiment, one crotch strap 310 passes through a through hole 410 of the buckle 40 to another side, and then the two positioning segments 3110 on two sides of the buckle 40 extend into one pair of limiting holes 110, so that the length of the crotch strap 310 in this design is non-adjustable. It should be understood that the crotch strap 310 may be made of a flexible material and have a certain degree of elasticity, but such elasticity is limited, and its main purpose is to withstand a large pulling force in an emergency, rather than exhibit significant elastic deformation like rubber or elastic fibers. Consequently, the crotch strap 310 may basically be regarded as a safety belt with a non-adjustable length.

In addition, referring to FIGS. 1 and 2, the safety seat 1 may further include a crotch strap protector 80. Optionally, the crotch strap protector 80 may be slidably fitted over a portion of the crotch strap 310 located between the buckle 40 and the seat portion 11 of the seat body 10. The crotch strap protector 80 is usually made of a soft material, which can protect skin of the passenger to reduce friction and pressure of the crotch strap 310 against the skin, avoiding redness or abrasion; and the soft crotch strap protector 80 can provide extra cushioning to make the passenger sit more comfortably and reduce discomfort during long rides.

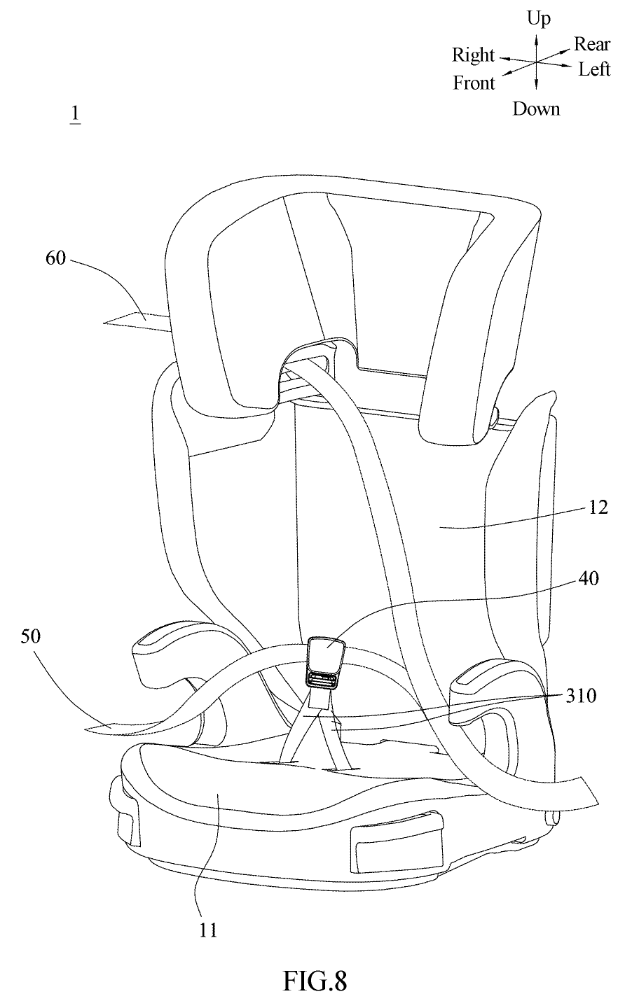

FIGS. 8 to 10 show a safety seat 1 according to a second embodiment of the present disclosure. The safety seat 1 may also include the seat body 10, the seat fabric structure 20, and the safety belt. However, the seat portion 11 and the backrest portion 12 of the seat body 10 are detachably connected. In addition, the safety belt of the safety seat 1 only includes the crotch strap assembly 30, and does not include the shoulder strap 60 and the waist strap 50. The crotch strap assembly 30 includes the crotch strap 310, and the crotch strap 310 passes through the seat fabric structure 20 to be connected to the seat portion 11. For a more comfortable sitting experience, the passenger can adjust a used length of the crotch strap 310 according to the body shape.

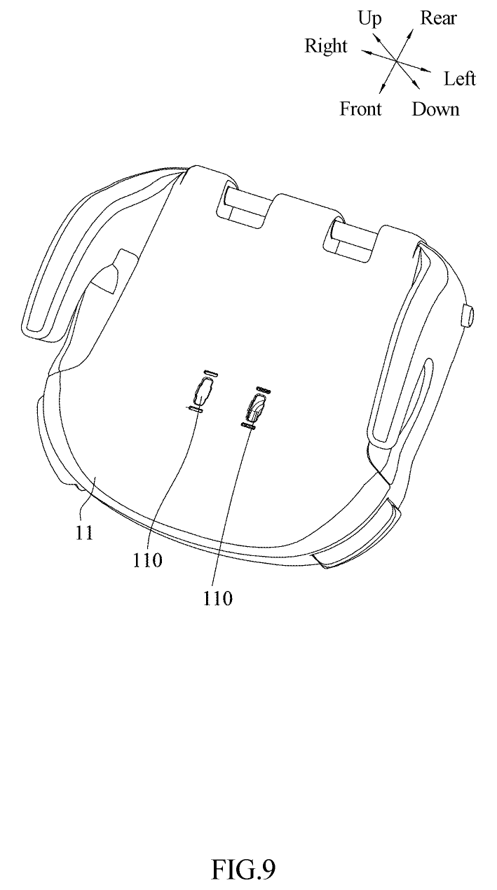

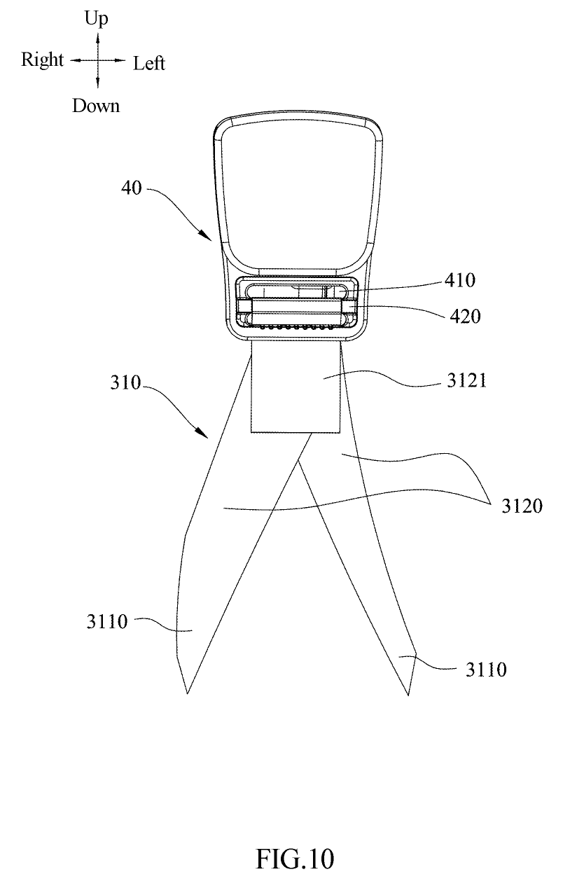

Optionally, as shown in FIGS. 8 and 9, the seat body 10 may have only two limiting holes 110. The two limiting holes 110 are disposed opposite to each other and spaced apart from each other in the second direction (i.e., the left-right direction) on the seat portion 11 of the seat body 10. That is, the position where the crotch strap 310 is connected to the seat body 10 is fixed; the crotch strap 310 adapts to passengers of different body shapes by adjusting the used length of the crotch strap (i.e., a length from the positioning segment 3110 to the buckle 40 of the safety seat 1). In addition, it can be understood that the blocking member 320 is not shown in FIG. 10 for the sake of brevity, but the positioning segment 3110 of the crotch strap 310 in this embodiment may also be connected with the blocking member 320 such as the above ladder buckle, or may form a bow by knotting itself, to prevent the positioning segment 3110 from disengaging from the limiting hole 110.

As shown in FIGS. 8 and 10, the buckle 40 is a waist strap positioning buckle, and the crotch strap 310 of the safety seat 1 is connected to the buckle 40. In such a case, a vehicle safety belt itself serves as the waist strap 50 and the shoulder strap 60 (i.e., in a booster use mode), and specifically, a part of the vehicle safety belt serving as the waist strap 50 is connected to the buckle 40. In addition, the crotch strap 310 may include an adjusting segment 3120 between the two positioning segments 3110, to adjust a length of the crotch strap 310 between the limiting hole 110 (or the positioning segment 3110) and the buckle 40. Optionally, as shown in FIG. 10, there may be only one crotch strap 310; however, different from the first embodiment, a connecting rod 420 is provided in the through hole 410 of the buckle 40 through which the crotch strap 310 passes. The crotch strap 310 is folded at a middle portion of its adjusting segment 3120 to form a folded portion 3121, and the folded portion 3121 is then wound on the connecting rod 420. After being wound on the connecting rod 420, the folded portion 3121 may be pulled away from the buckle 40 and locked by the buckle 40, thereby forming a redundant (unused) portion. A length of the unused portion of the crotch strap 310 (or the adjusting segment 3120) may be adjusted by pulling the folded portion 3121, and hence the length of the crotch strap 310 between the buckle 40 and the limiting hole 110 may be adjusted. Alternatively, the crotch strap 310 may include two branch straps, i.e., the crotch strap 310 substantially forms an inverted Y-shape, and a vertical segment of the inverted Y-shape is wound around the connecting rod 420 of the buckle 40 and may be pulled to adjust the length of the unused portion of the adjusting segment 3120. Certainly, the present disclosure is not limited thereto. Generally, for a passenger with a larger body shape, the length of the unused portion of the adjusting segment 3120 can be reduced to increase the used length of the crotch strap 310, i.e., to increase the length of the crotch strap 310 from the limiting hole 110 to the buckle 40; for a passenger with a smaller body shape, the length of the unused portion of the adjusting segment 3120 can be increased to reduce the used length of the crotch strap 310, i.e., to reduce the length of the crotch strap 310 from the limiting hole 110 to the buckle 40.

It should be understood that the waist strap positioning buckle in the second embodiment shown in FIGS. 8 to 10 may also be applied to the first embodiment shown in FIGS. 1 to 7. In such a case, the safety belt in the first embodiment only includes the crotch strap assembly, the vehicle safety belt serves as the waist strap and the shoulder strap, and the waist strap positioning buckle is connected to the part of the vehicle safety belt serving as the waist strap. Accordingly, the crotch strap 310 in this case may be configured to be capable of both adjusting its connection position with the seat portion 11 of the seat body 10 and adjusting its own used length. Alternatively, the connecting rod 420 is also provided in the through hole 410 of the buckle 40 in the first embodiment, to allow the crotch strap 310 of the first embodiment to be wound around the connecting rod 420 after being folded, that is, the crotch strap 310 may be configured to be capable of both adjusting its connection position with the seat portion 11 of the seat body 10 and adjusting its own used length.

It should be understood that the safety seat 1 in the second embodiment shown in FIGS. 8 to 10 may also include the crotch strap protector 80 of the first embodiment shown in FIGS. 1 to 7.

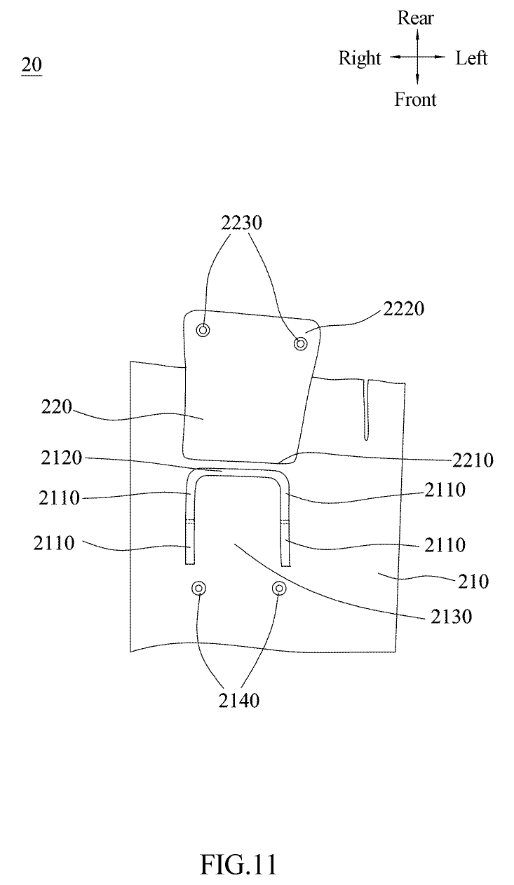

Since the seat body 10 is provided with the limiting holes 110, the seat fabric structure 20 covering the seat body 10 also needs to be provided with corresponding slots to allow the crotch strap 310 to pass through. The seat fabric structure 20 will be described in detail below with reference to FIGS. 11 to 14.

As shown in FIGS. 11 to 13, the seat fabric structure 20 may include a seat fabric 210 and a shielding piece 220. The seat fabric 210 covers the seat body 10, and is provided with a through slot 2110 through which the crotch strap 310 may pass. The shielding piece 220 may be provided on the seat fabric 210 and shield the through slot 2110. After the positioning segment 3110 of the crotch strap 310 passes through the through slot 2110 and the limiting hole 110 in sequence to connect with the seat portion 11, the shielding piece 220 may shield the through slot 2110; that is, at least a part of the crotch strap 310 extends to an outer side of the shielding piece 220. Optionally, a first end 2210 of the shielding piece 220 is fixedly connected to the seat fabric 210 (for example, by a stitching process), while a second end 2220 of the shielding piece 220 is detachably connected to the seat fabric 210, so that the shielding piece 220 is more reliable and less likely to displace during use, thereby better shielding the through slot 2110. Optionally, the shielding piece 220 may include a first connecting portion 2230 at the second end 2220, and the seat fabric 210 may include a second connecting portion 2140 at a position corresponding to the second end 2220. The first connecting portion 2230 and the second connecting portion 2140 are, for example, a male fastener and a female fastener engaging with each other, a hook surface and a loop surface fitting with each other, or a magnet and a metal attracting each other. Alternatively, the first end 2210 and the second end 2220 of the shielding piece 220 are both detachably connected to the seat fabric 210, that is, first connecting portions 2230 may be provided at both the first end 2210 and the second end 2220, and the seat fabric 210 may be also correspondingly provided with second connecting portions 2140 at two positions, so that the shielding piece 220 can be conveniently detached for separate replacement in case of wear or stains.

As described above, the crotch strap 310 and the seat portion 11 of the seat body 10 may be connected at a single point, and the adjustment of the crotch strap 310 may be realized by adjusting the connection position instead of adjusting its own used length. In this case, the seat portion 11 of the seat body 10 is provided with a plurality of limiting holes 110, and the seat fabric 210 is correspondingly provided with a plurality of through slots 2110 corresponding to the plurality of limiting holes 110 to allow the crotch strap 310 to pass through, and the shielding piece 220 may simultaneously cover all the through slots 2110. Alternatively, the adjustment of the crotch strap 310 may be realized by adjusting its own used length instead of adjusting the connection position. In this case, the seat portion 11 of the seat body 10 may be provided with only a single limiting hole 110, the seat fabric 210 is correspondingly provided with one through slot 2110 through which the crotch strap 310 may pass, and the shielding piece 220 can cover this single through slot 2110.

In addition, the crotch strap 310 and the seat portion 11 of the seat body 10 may be connected at multiple points. In this case, the seat body 10 may be provided with one pair of limiting holes 110 (e.g., the seat body 10 is provided with one pair of limiting holes 110 in the second embodiment shown in FIGS. 8 to 10) or a plurality of pairs of limiting holes 110 (e.g., the seat body 10 is provided with two pairs of limiting holes 110 in the first embodiment shown in FIGS. 1 to 7); the seat fabric 210 is also correspondingly provided with one pair of through slots 2110 or a plurality of pairs of through slots 2110 through which the crotch strap 310 may pass; and the shielding piece 220 may cover all the through slots 2110. When there is only one pair of through slots 2110, a dimension of the shielding piece 220 in the first direction (i.e., the front-rear direction) is greater than or equal to a dimension of each through slot 2110 in the first direction, and a dimension of the shielding piece 220 in the second direction (i.e., the left-right direction) is greater than or equal to a sum of a distance between two through slots 2110 of this pair of through slots 2110 in the second direction and dimensions of the two through slots 2110 themselves (or slot widths) in the second direction. When there are a plurality of pairs of through slots 2110, the dimension of the shielding piece 220 in the first direction (i.e., the front-rear direction) is greater than or equal to a distance between two points, which are distanced farthest apart in the front-rear direction, of two pairs of through slots 2110 distanced farthest apart along the first direction, and the dimension of the shielding piece 220 in the second direction (i.e., the left-right direction) is greater than or equal to a distance between two points, which are distanced farthest apart in the left-right direction, of paired two through slots 2110, that is, a sum of the distance between two through slots 2110 of the paired through slots 2110 in the second direction and the dimensions of the two through slots 2110 themselves (or slot widths) in the second direction.

In a situation where the seat body 10 is provided with a plurality of pairs of limiting holes 110, the seat fabric 210 also includes a plurality of pairs of through slots 2110 to allow the crotch strap 310 at different positions to pass through. For example, in a first implementation shown in FIG. 11, along the front-rear direction of the safety seat 1, the seat fabric 210 has two pairs of through slots 2110 (which may be correspondingly applied to the first embodiment shown in FIGS. 1 to 7); each pair of through slots 2110 includes two through slots 2110 oppositely disposed in the left-right direction of the safety seat 1; and two through slots 2110 located on a same side (left side or right side) and belonging to different pairs are in communication with each other (i.e., the two through slots 2110 form a continuous slot). That is, the dimension of the shielding piece 220 in the front-rear direction is greater than or equal to a distance between two points, which are distanced farthest apart in the front-rear direction, of the two through slots 2110 located on the same side. Moreover, the dimension of the shielding piece 220 in the left-right direction is greater than or equal to a sum of a distance between the two through slots 2110 oppositely disposed in the left-right direction and dimensions of the two through slots 2110 themselves in the left-right direction, or greater than a distance between two points, which are distanced farthest apart along the left-right direction, of the two through slots 2110.

However, it should be understood that the present disclosure is not limited thereto. For example, the seat fabric 210 may have three, four or more pairs of through slots 2110 along the front-rear direction, and all the through slots 2110 located on the same side (left side or right side) and belonging to different pairs are in communication with each other. In such a case, the dimension of the shielding piece 220 in the front-rear direction is greater than or equal to a distance between two points, which are distanced farthest apart in the front-rear direction, of two through slots 2110 that are distanced farthest apart among all the through slots 2110.

In addition, the seat fabric 210 further has a connecting slot 2120 extending along the second direction, and two through slots 2110 in at least one pair of through slots are in communication with each other via the connecting slot 2120. Optionally, the shielding piece 220 may also cover the connecting slot 2120.

For example, in the first implementation shown in FIG. 11, the connecting slot 2120 is provided between a rear pair of through slots in FIG. 11, so that the two through slots 2110 in this pair are in communication with each other via the connecting slot 2120, and hence the connecting slot 2120 and these two pairs of through slots 2110 are mutually in communication to form an inverted U-shaped slot. It can be understood that the connecting slot 2120 may also be provided between a front pair of through slots 2110 in FIG. 11, so that the connecting slot 2120 and these two pairs of through slots 2110 are mutually in communication to form a U-shaped slot. In addition, when the seat fabric 210 has more than two pairs of through slots 2110 along the front-rear direction, on the same side (left side or right side) of the second direction, all the through slots 2110 belonging to different pairs may be in communication with each other, so that a single connecting slot 2120 may suffice and may be in communication with all the through slots 2110, thereby forming a U-shape or an inverted U-shape overall. That is, the connecting slot 2120 may be connected to ends (i.e., a frontmost end or a rearmost end) of two through slots 2110 in a pair of through slots 2110 located at an end (i.e., a frontmost end or a rearmost end) along the front-rear direction. Optionally, when the connecting slot 2120 is connected to the pair of through slots 2110 located at the frontmost end along the front-rear direction, the connecting slot 2120 is between front ends of two through slots 2110 in this pair of through slots 2110 (i.e., ends not in communication with other through slots 2110 on the same side); when the connecting slot 2120 is connected to the pair of through slots 2110 located at the rearmost end along the front-rear direction, the connecting slot 2120 is between rear ends of two through slots 2110 in this pair of through slots 2110 (i.e., ends not in communication with other through slots 2110 on the same side).

In addition, the connecting slot 2120 and the through slots 2110 forming the U-shape or the inverted U-shape may define an adjusting piece 2130 from the seat fabric 210. Since the adjusting piece 2130 is cut out from the seat fabric 210 through the connecting slot 2120 and the through slots 2110, an outline of the adjusting piece 2130 is also U-shaped or inverted U-shaped. Optionally, one side (front side or rear side) of the adjusting piece 2130 remains connected to or integrated with the seat fabric 210, while other sides of the adjusting piece 2130 are separated from the seat fabric 210 by the connecting slot 2120 and the through slots 2110, so that the adjusting piece 2130 may be flipped open, facilitating user adjustment of the connection position between the crotch strap 310 and the seat body 10. Optionally, the connecting slot 2120 is positioned closer to the first end 2210 (fixed end) of the shielding piece 220 relative to the second connecting portion 2140, so that a flipping direction of the adjusting piece 2130 is opposite to a flipping direction of the shielding piece 220, thereby preventing the adjusting piece 2130 from being opened as well and guarding against the child’s fingers entering the limiting holes 110 of the seat body 10 when the shielding piece 220 is flipped open by a child.

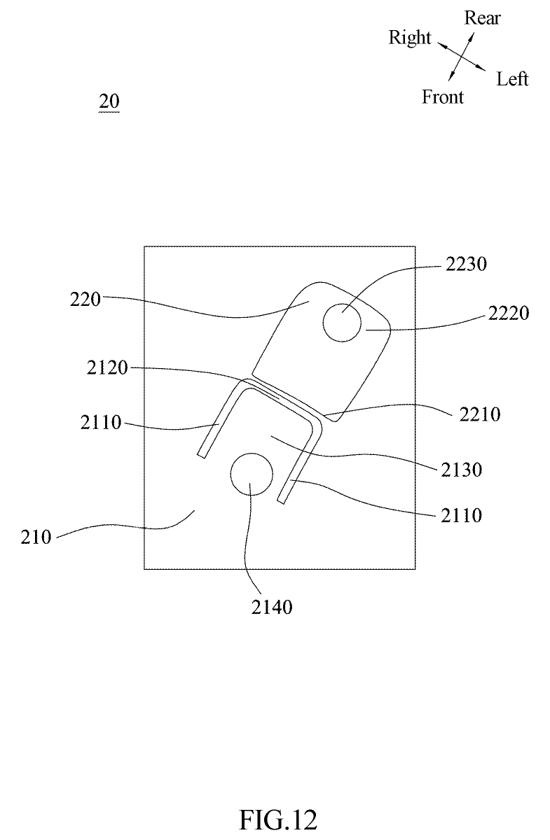

A second implementation shown in FIG. 12 corresponds to a situation where the seat body 10 is provided with only one pair of limiting holes 110 (which may be applied to the second embodiment as shown in FIGS. 8 to 10). Consequently, in this embodiment, the seat fabric 210 is provided with only one pair of through slots 2110. The specific arrangement of this pair of through slots 2110 may refer to the arrangement of any pair of through slots 2110 in the first implementation as shown in FIG. 11. In addition, the connecting slot 2120 and this pair of through slots 2110 may also form a U-shape or an inverted U-shape, and the specific layout may also refer to the first implementation and will not be repeated here.

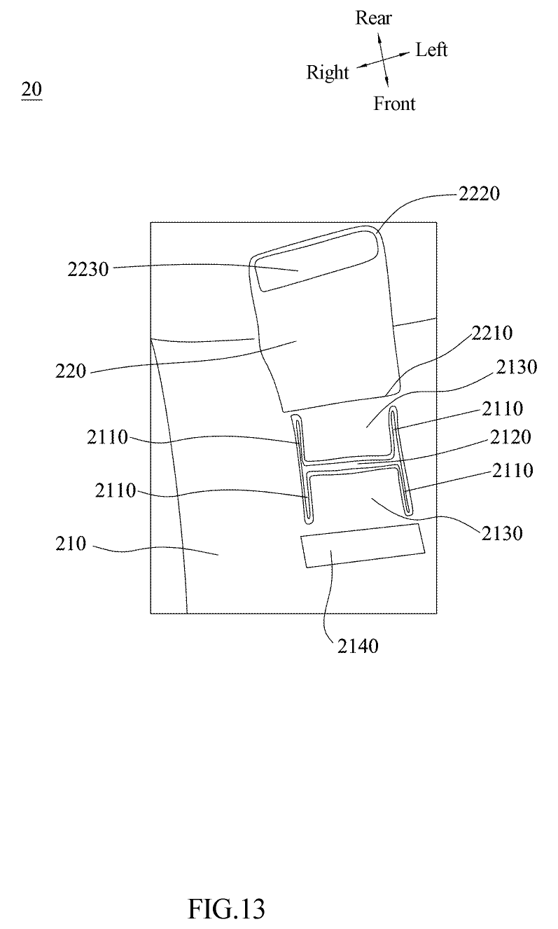

In a third implementation as shown in FIG. 13, along the front-rear direction of the safety seat 1, the seat fabric 210 similarly has two pairs of through slots 2110 (which may be applied to the embodiment as shown in FIGS. 1 to 7). The arrangement of the through slots 2110 and the dimension of the shielding piece 220 may specifically refer to the description about FIG. 11, and thus will not be repeated here. However, the arrangement of the connecting slot 2120 in the third implementation is different from that in the first implementation. Optionally, the connecting slot 2120 is provided between the two pairs of through slots 2110 along the front-rear direction and is in communication with the two pairs of through slots 2110, i.e., the connecting slot 2120 and the two pairs of through slots 2110 form an H-shape. That is, one connecting slot 2120 is simultaneously connected to rear ends of two through slots 2110 in the front pair of through slots 2110 and front ends of two through slots 2110 in the rear pair of through slots 2110. It can be understood that when the seat fabric 210 includes more than two pairs of through slots 2110, the connecting slot 2120 may be located between two adjacent pairs of through slots 2110 along the front-rear direction. In this case, the connecting slot 2120 and the through slots 2110 forming the H-shape may define two adjusting pieces 2130 from the seat fabric 210; a rear side of the rear adjusting piece 2130 is connected to or integrated with the seat fabric 210, and a front side of the front adjusting piece 2130 is connected to or integrated with the seat fabric 210; and the two adjusting pieces 2130 may be pivoted and flipped open in opposite directions relative to each other.

In addition, it can be seen from the comparison between the first implementation and the third implementation that, in the first implementation, the connecting slot 2120 and the through slots 2110 forming the U-shape or inverted U-shape overall can be formed by one-time cutting, thereby simplifying the process of producing the seat fabric 210 and improving the production efficiency, whereas in the third implementation, the connecting slot 2120 and the through slots 2110 forming the H-shape overall can cut out more than one adjusting piece 2130, thereby realizing zoned adjustment, which is particularly advantageous when there are more than two pairs of through slots 2110. For example, when the seat portion 11 has four pairs of limiting holes 110 arranged along the front-rear direction and the seat fabric 210 correspondingly has four pairs of through slots 2110, the through slots 2110 in different pairs are in communication with each other, and the connecting slot 2120 is positioned between two middlemost pairs of through slots 2110. In this configuration, when the connection position of the crotch strap 310 needs to be adjusted only between two relatively forward pairs of limiting holes 110, it is possible to only flip open the front adjusting piece 2130 for adjustment. Similarly, when the connection position of the crotch strap 310 needs to be adjusted between two relatively rearward pairs of limiting holes 110, it is possible to only flip open the rear adjusting piece 2130 for adjustment. Thus, the adjustment of the crotch strap can be realized more conveniently and quickly. Optionally, the connecting slot 2120 may be provided between the first pair of through slots 2110 and the second pair of through slots 2110, or provided between the third pair of through slots 2110 and the fourth pair of through slots 2110, that is, the connecting slot 2120 may be provided between any two adjacent pairs of through slots 2110.

Although the above description mainly discusses the situation where the through slots 2110 belonging to different pairs and located on the same side (left side or right side) in the second direction are all in communication with each other, at least two adjacent through slots 2110 belonging to different pairs and located on the same side (left side or right side) in the second direction may also be separated. That is, at least part of the through slots 2110 among the plurality of through slots 2110 belonging to different pairs may be separated (discontinuous), i.e., spaced apart by the seat fabric 210. Optionally, all the through slots 2110 belonging to different pairs and located on the same side may be separated, or some through slots 2110 among all the through slots 2110 belonging to different pairs and located on the same side are in communication while other through slots are separated.

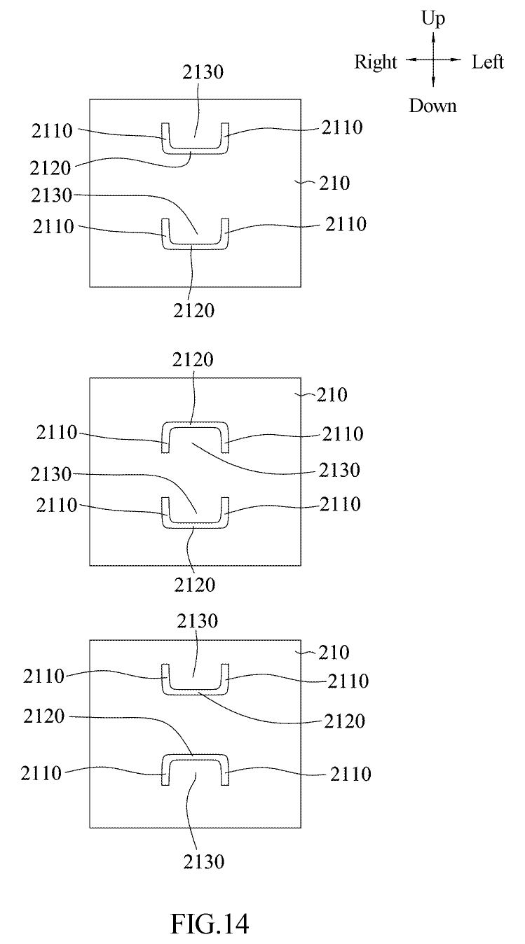

In a situation where the through slots 2110 are separated, the seat fabric 210 may have a plurality of connecting slots 2120 arranged along the first direction, so that a plurality of adjusting pieces 2130 may be formed. Moreover, when the plurality of pairs of through slots 2110 arranged along the first direction are all spaced apart from each other, the number of the connecting slots 2120 and the number of the adjusting pieces 2130 may be equal to the number of pairs of through slots 2110. For example, in other implementations as shown in FIG. 14, two pairs of through slots 2110 are spaced apart in the first direction (front-rear direction), that is, two through slots 2110 located on the left side or the right side are separated from each other. In FIG. 14, the shielding piece 220 is omitted, and as described in the above implementations, the shielding piece 220 is configured to cover all the through slots 2110 and has a first end fixedly connected to the seat fabric 210 and a second end detachably connected to the seat fabric 210. Each of the two pairs of through slots 2110 is in communication through one connecting slot 2120, so that the two pairs of through slots 2110 and the two connecting slots 2120 may form two U-shapes with openings facing a common direction, or form two U-shapes with openings facing each other (i.e., one inverted U-shape and one upright U-shape), or form two U-shapes with openings facing away from each other (i.e., one upright U-shape and one inverted U-shape). In each case, two adjusting pieces 2130 are formed.

Certainly, it can be understood that the present disclosure is not limited to the layouts as shown in FIG. 14. For example, when the seat fabric 210 is provided with three or more pairs of through slots 2110, the plurality of through slots 2110 and the plurality of connecting slots 2120 may also form a combination of a U-shape and an H-shape.

To adjust the connection position between the crotch strap 310 and the seat body 10, individual pairs of limiting holes 110 on the seat body 10 are spaced apart from each other, while the corresponding pairs of through slots 2110 on the seat fabric 210 may be in communication with each other or separated from each other, or may be partially in communication or partially separated, but two through slots 2110 of at least one pair of through slots 2110 are in communication through one connecting slot 2120. Optionally, the plurality of pairs of through slots 2110 corresponding to the plurality of pairs of limiting holes 110 are all spaced apart in the first direction, in which case the through slots 2110 on the seat fabric 210 may also restrict displacement of the crotch strap 310 in a plane defined by the seat fabric 210. In particular, when the seat fabric 210 has a certain thickness (or the seat fabric structure 20 further includes a seat cushion), the through slots 2110 may function to restrict the crotch strap 310 after the positioning segments 3110 extend into the limiting holes 110, to avoid undesired front-rear displacement of the crotch strap 310 within a thickness range of the seat fabric 210.

Optionally, in other embodiments, the seat fabric structure 20 may only include the seat fabric 210 without the shielding piece 220. The seat fabric 210 may have the through slots 2110 and the connecting slots 2120 as described in any of the above embodiments, without the shielding piece 220 to cover the through slots 2110 and the connecting slots 2120.

In conclusion, the seat fabric structure 20 and the safety seat 1 including the seat fabric structure 20 according to the present disclosure can, on the one hand, realize rapid adjustment of the crotch strap 310 through the plurality of pairs of limiting holes 110, the plurality of pairs of through slots 2110, and the adjusting piece 2130 to adapt to passengers of different body shapes, and on the other hand, ensure flatness of the seat fabric 210 by shielding the through slots 2110 on the seat fabric 210 using the shielding piece 220. The flatness cannot only upgrade the overall aesthetics of the safety seat 1, but also improve the comfort of sitting on the safety seat 1, because the seat fabric at the through slots 2110 is exactly at the passenger’s crotch, and wrinkled seat fabric may cause friction against the skin of the passenger, resulting in discomfort and even potentially causing skin redness or abrasion. Consequently, the flat seat fabric can provide a smoother and more comfortable surface, reduce friction, improve sitting comfort, maintain better breathability, reduce accumulation of sweat and moisture, and keep the seat dry, especially in hot summer, which can significantly enhance sitting comfort.

Other embodiments of this application will be readily conceivable for those skilled in the art after considering the specification and practicing this application disclosed herein. This application is intended to cover any variations, uses, or adaptive changes of this application, which follow general principles of the present disclosure and include common knowledge or conventional technical means in the art not disclosed herein. The specification and embodiments are merely exemplary, and the true scope of this application is defined by the claims of this application.

Although this application has been described with reference to typical embodiments, the terms used are descriptive and exemplary rather than restrictive. Since this application can be specifically embodied in various forms without departing from the essence and principle of this application, it should be understood that the above embodiments are not limited to any of the foregoing details, but should be interpreted in the broadest sense within the scope defined by the claims. Therefore, all changes falling within the scope of the claims or their equivalents should be covered by the claims.

What is claimed is:

1. A seat fabric structure for a safety seat, comprising:
a seat fabric covering a seat body of the safety seat, and having at least one through slot to allow a crotch strap of the safety seat to pass through; and
a shielding piece connected to the seat fabric and configured to shield the at least one through slot.

2. The seat fabric structure according to claim 1, wherein a first end of the shielding piece is fixedly connected to the seat fabric, and a second end of the shielding piece is detachably connected to the seat fabric.

3. The seat fabric structure according to claim 1, wherein the at least one through slot comprises at least one pair of through slots, the at least one pair of through slots are provided on the safety seat along a first direction of the safety seat,
each pair of the at least one pair of through slots comprises two through slots disposed opposite to each other in a second direction of the safety seat,
wherein the second direction is perpendicular to the first direction.

4. The seat fabric structure according to claim 3, wherein a dimension of the shielding piece in the second direction is greater than or equal to a sum of a distance between two through slots in each pair of the at least one pair of through slots and dimensions of the two through slots in the second direction.

5. The seat fabric structure according to claim 3, wherein a dimension of the shielding piece in the first direction is greater than or equal to a distance between two points of all of the at least one pair of through slots which are distanced farthest apart in the first direction.

6. The seat fabric structure according to claim 3, wherein the seat fabric further has at least one connecting slot extending along the second direction,
at least one pair of the at least one pair of through slots are in communication with each other via one of the at least one connecting slot.

7. The seat fabric structure according to claim 6, wherein the at least one pair of through slots comprises at least two pairs of through slots, and all the through slots located on a same side of the second direction and belonging to different pairs are in communication with each other.

8. The seat fabric structure according to claim 7, wherein the one of the at least one connecting slot is connected to ends of the one pair of the at least two pairs of through slots located at an end along the first direction.

9. The seat fabric structure according to claim 7, wherein the one of the at least one connecting slot is located between two adjacent pairs of the at least two pairs of through slots, and is simultaneously in communication with the two adjacent pairs of the at least two pairs of through slots.

10. The seat fabric structure according to claim 3, wherein the at least one pair of through slots comprises at least two pairs of through slots, and at least two adjacent through slots located on a same side of the second direction and belonging to different pairs are separated from each other.

11. The seat fabric structure according to claim 10, wherein each pair of the at least two pairs of through slots are in communication through one connecting slot.

12. The seat fabric structure according to claim 6, wherein the one of the at least one connecting slot and the through slots in communication with the one of the at least one connecting slot define an adjusting piece from the seat fabric, one side of the adjusting piece is integrated with the seat fabric, and other sides of the adjusting piece are separated from the seat fabric by the one of the at least one connecting slot and the through slots.

13. A safety seat, comprising:
a seat body having at least one limiting hole;
a seat fabric covering the seat body and having at least one through slot corresponding to the at least one limiting hole;
a shielding piece connected to the seat fabric and configured to shield the at least one through slot; and
a crotch strap assembly passing through the at least one through slot and the at least one limiting hole to be connected to the seat body.

14. The safety seat according to claim 13, wherein the crotch strap assembly comprises a crotch strap, and the crotch strap extends from an outer side of the shielding piece into the at least one through slot and the at least one limiting hole.

15. The safety seat according to claim 13, wherein the at least one limiting hole comprises at least one pair of limiting holes, the at least one pair of limiting holes are provided on the safety seat along a first direction of the safety seat, and each pair of the at least one pair of limiting holes comprises two limiting holes disposed opposite to each other in a second direction of the safety seat, wherein the second direction is perpendicular to the first direction;
the seat fabric has a corresponding pair of through slots corresponding to each pair of the at least one pair of limiting holes.

16. The safety seat according to claim 15, wherein the at least one pair of limiting holes comprises at least two pairs of limiting holes;
on a same side of the second direction, any two adjacent limiting holes belonging to different pairs are separated from each other, and all the through slots belonging to different pairs are in communication with each other.

17. The safety seat according to claim 15, wherein the crotch strap comprises two positioning segments, and the two positioning segments respectively pass through two limiting holes in any one pair of the at least one pair of limiting holes.

18. The safety seat according to claim 17, wherein the crotch strap assembly further comprises two blocking members, and the two blocking members are respectively connected to the two positioning segments to prevent the two positioning segments from disengaging from the one pair of the at least one pair limiting holes.

19. The safety seat according to claim 15, wherein the seat fabric further has at least one connecting slot extending along the second direction, and at least one pair of the at least one pair of through slots are in communication via the at least one connecting slot.

20. The safety seat according to claim 19, wherein a first end of the shielding piece is fixedly connected to the seat fabric, while a second end of the shielding piece is detachably connected to the seat fabric, and the at least one connecting slot is closer to the first end than the second end.
